(19) United States
(12) Patent Application Publication
(10) Pub. No.: US 2007/0214705 A1
(43) Pub. Date: Sep. 20, 2007

(54) Apparatus for securing an object to a tubular member

(75) Inventors: Douglas J. Osenbauch, New Ringgold, PA (US); Daniel Triano, New Ringgold, PA (US)

Correspondence Address: JOHN F. LETCHFORD, ARCHER & GREINER, P.C., ONE CENENNIAL SQUARE, HADDONFIELD, NJ, 08033, US

(73) Assignee: Far Out Fishin, LLC, New Ringgold, PA (US)

(21) Appl. No.: 11/724,985

(22) Filed: Mar. 16, 2007

Related U.S. Application Data
(60) Provisional application No. 60/783,264, filed on Mar. 17, 2006.

(51) Int. Cl. A01K 91/02

(52) U.S. Cl. 43/19

(57) ABSTRACT

Apparatus for securing an object to a tubular member. The apparatus includes anchorage structure for releasably engaging a tubular member and structure for connecting an object to the anchorage structure. Additionally, the apparatus includes structure carried by the connecting structure for adjusting the pitch of an object carried by the apparatus.

### CROSS REFERENCE TO RELATED APPLICATION(S)

The present application claims the benefit of U.S. Provisional Patent Application No. 60/783,264, filed Mar. 17, 2006, and is related to U.S. patent application Ser. No. 11/229,993, filed Sep. 19, 2005, which claimed the benefit of U.S. Provisional Patent Application No. 60/611,861, filed Sep. 20, 2004, both of which are incorporated herein in their entireties by reference thereto.

### FIELD OF THE INVENTION

The present invention relates in general to apparatus for securing objects to a tubular member and, in particular, to apparatus for releasably and adjustably securing objects to a tubular member including means for adjusting the attitude of objects supported by the apparatus.

### BACKGROUND OF THE INVENTION

Devices for releasably and adjustably securing objects to a tubular member are known in the art. A typical device employs opposed anchor means in the form of anchor members having cooperating sloped, wedge-like surfaces. In a contracted or inoperative position, the anchor members are essentially in alignment with one another to permit insertion of the device into and withdrawal of the device from a tubular member, as well as adjustment of the position of the device in the tubular member. In an expanded or operative position, the anchor members diverge along their cooperating sloped surfaces to frictionally or compressively engage the inner wall(s) of the tubular member to secure the device to the tubular member.

Examples of such devices are described in U.S. Pat. Nos. 1,103,839; 1,772,240; 1,859,223; 2,643,143; 3,527,355; 4,023,649; 4,195,535 and 6,045,109. Among these, all but U.S. Pat. No. 6,045,108 teach the use of various spring-biased pedals, levers and related means for releasing the anchor members from engagement with a tubular member. In contrast, U.S. Pat. No. 6,045,108 uses a threaded nut engaging a threaded rod to compressively urge the anchor members into their operative and inoperative positions. Alternative compression means are also disclosed in that patent, namely, a ratchet and an eccentric cam mechanism. All exemplary embodiments of U.S. Pat. No. 6,045,108 disclose use of the apparatus in connection with securing objects to the tubular fishing rod holders commonly present on a boat. As is known, such fishing rod holders generally have circular or oval cross-sectional shapes.

In all embodiments disclosed in U.S. Pat. No. 6,045,108, the proximal portion of the rod, which supports objects to be carried by the apparatus, is oriented at an angle defined by a bend formed between the proximal and distal portions of the rod. Along with the threaded nut the distal portion of the rod is involved in urging the anchor members into their clamping position and returning the anchor members to their contracted insertion/withdrawal position. A disadvantage of using a bent rod as both an anchorage mechanism and an object support device is that the angle between the proximal and distal portions of the rod is fixed by the angle defined by the bend in the rod. Consequently, the distal, object-supporting end of the rod may only assume a very limited range of positions in which objects may be practically supported by the device. More particularly, the proximal end of the bent rod may only rotate in space through a single and immutable conical path defined by the angle of the bend as the distal portion of the rod is rotated about its longitudinal axis within the anchor members. As a practical matter, a substantial portion of such rotational motion is of little or no use. That is, depending on the object carried by the device, the range of useful motion of the proximal portion of the bent rod from vertical may range from perhaps as great as about 45° in either direction (for objects such as an umbrella as shown in FIG. 1) to just a very few degrees in either direction from vertical for the cooking grill also shown in FIG. 1. Further, the fixed angle defined by the bend formed between the proximal and distal portions of the rod permit no adjustment of the “pitch” of the proximal end of the rod versus the distal end of the rod. An advantage of pitch adjustability is that it allows an object carried by a tubular member securement device to assume a wide range of useful positions regardless of the extent of rotation of the device about its longitudinal axis within the tubular member.

An advantage exists, therefore, for an apparatus for securing an object to a tubular member that includes attitude adjustment means for adjusting the pitch of an object carried by the apparatus.

### SUMMARY OF THE INVENTION

The present invention relates to a novel and improved apparatus for securing an object to a tubular member. The apparatus includes anchor means for releasably engaging a tubular member and means for connecting an object to the anchor means. Additionally, the apparatus includes attitude adjustment means carried by the connecting means for adjusting the pitch of an object carried by the apparatus.

Objects that may be supported by the apparatus according to the invention are myriad. For example, such objects may include, without limitation, tables, poles, food and/or beverage holders, optical devices such as telescopes and cameras, easels or other writing or artistic boards, food and/or beverage storage or preparation devices such as coolers or grills, sunlight or precipitation blocking devices such as umbrellas, lighting fixtures, and sporting equipment such as fishing rods or guns. According to an exemplary embodiment, an object that may be advantageously supported by the instant apparatus is a fishing bait casting device such as, for example, that disclosed in U.S. patent application Ser. No. 11/229,993.

Likewise, the configuration and types of tubular members to which the present apparatus may be secured are essentially limitless. The tubular members may be any size or shape. Moreover, they may assume any peripheral configuration such as circular, ellipsoid, substantially square or rectangular or other polygonal shape, or any combination of linear and curvilinear segments.

In the context of sport or leisure fishing, for example, the tubular members may be any conventional fishing rod holders, regardless of whether the rod holders are provided in a boat or similar vessel, in beach carts, or metal or plastic tubes embedded into shoreline soils adjacent bodies of water.

### BRIEF DESCRIPTION OF THE DRAWINGS

The invention will become more readily apparent from the following description of preferred embodiments thereof shown, by way of example only, in the accompanying drawings wherein:

FIG. 1 is a front elevation view of a first embodiment of an apparatus according to the present invention for securing an object to a tubular member (with certain elements omitted for clarity), as well as an object supported thereby;

FIG. 2 is a side elevation view of the apparatus of FIG. 1;

FIG. 3 is an enlarged front elevation view of an attitude adjustment means of a further embodiment of an apparatus according to the present invention;

FIG. 4 is a side elevation view of the attitude adjustment means of FIG. 3;

FIG. 5 is an elevational, partial cross section view of the anchor means portion of the apparatus the present invention in an inoperative position within a tubular member; and

FIG. 6 is an elevational, partial cross section view of the anchor means portion of the apparatus the present invention in an operative position within a tubular member.

### DETAILED DESCRIPTION OF THE INVENTION

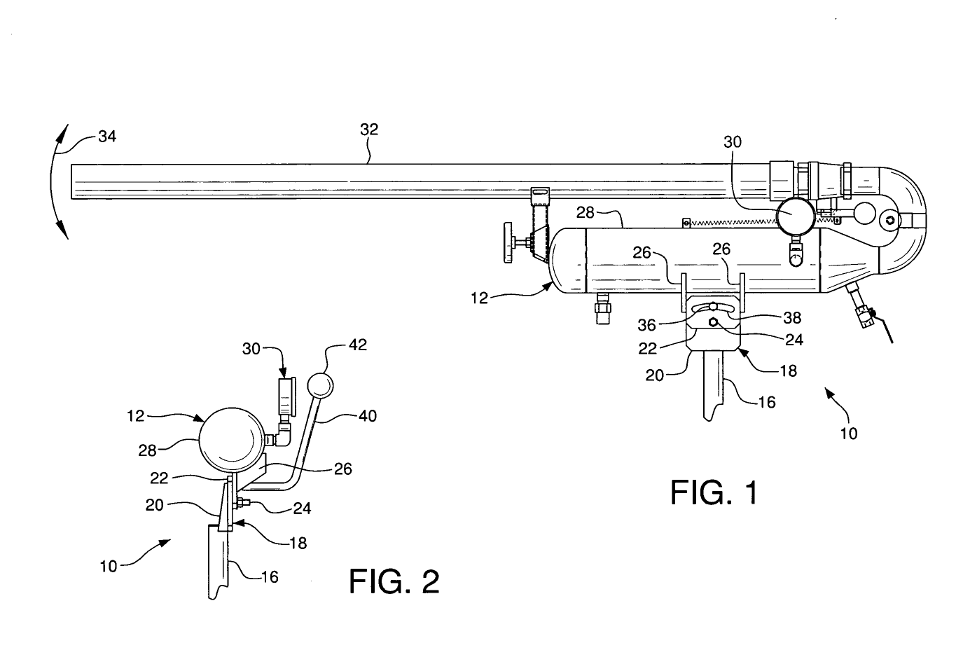

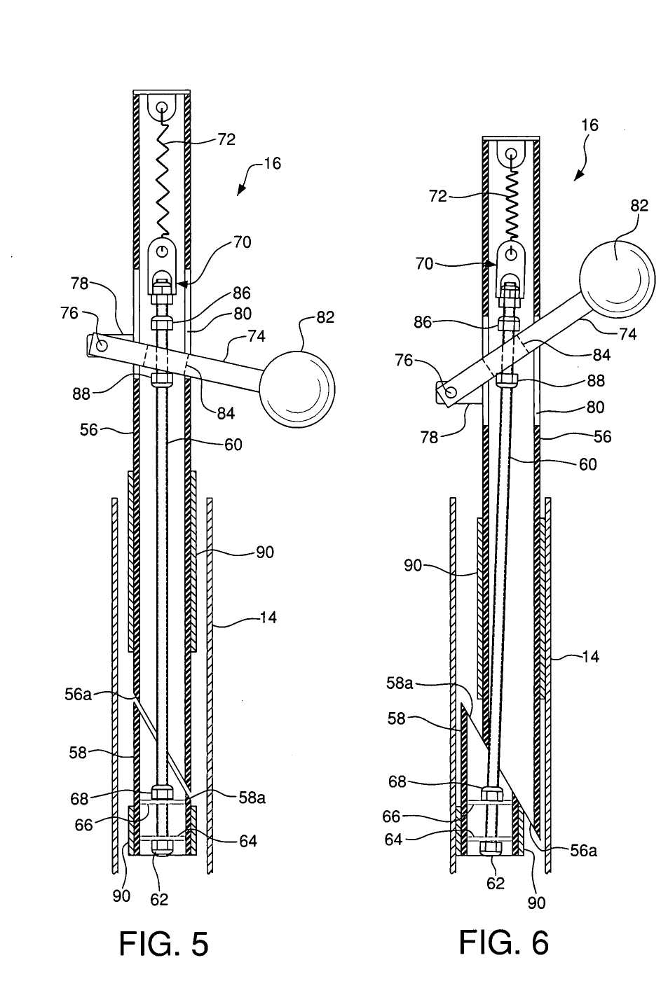

Referring to the drawings wherein like or similar references indicate like or similar elements throughout the several views, there is shown in FIGS. 1 and 2 a first embodiment of an apparatus according to the present invention, identified generally by reference numeral 10, for securing an object 12, to a tubular member such as the tubular member 14 shown in FIGS. 5 and 6. Object 12 may be any object which may find suitable application in any context or environment where it might be useful to be releasably secured to a tubular member. By way of example, not limitation, object 12 may be a fishing bait casting device such as, for example, that disclosed in U.S. patent application Ser. No. 11/229,993. For clarity, the following discussion will refer only to certain elements of the fishing bait casting device (object 12) to provide the reader with an appreciation of the beneficial relationship of apparatus 10 with but one object for which pitch adjustability is advantageous.

Apparatus 10 comprises anchor means 16, which are described in detail in connection with FIGS. 5 and 6, and means 18 for connecting object 12 to the anchor means. According to the present invention, connecting means 18 comprises a first bracket member 20 connected to the upper portion of anchor means 16. First bracket member 20 may fixedly attached to the anchor means, such as by bonding, welding or the like, or it may be releasably attached thereto via mechanical fastening means such as, for example, screws, bolts, clamping means, and the like. Connecting means 18 further comprises a second bracket member 22 pivotally connected to first bracket member 20 via pivot 24, which pivot may be a nut and bolt or other structure suitable to function as a connection for pivotally connecting the first and second bracket members.

Second bracket member 22 further includes means 26 for connecting the second bracket to the object to be supported by apparatus 10. In the illustrated example, such object connecting means is embodied as a pair of flanges or gussets fixedly secured by welding, bonding or the like to a pressurizable gas tank 28 of the fishing bait casting device (object 12). It will be understood, however, that second bracket member 22 may also be releasably connected to tank (or any object) by any variety of releasable connectors carried by the second bracket member, and perhaps cooperating connecting means carried by the tank (or other object). Such connectors may include, without limitation, belts or straps, clamps, cooperating clasps or other releasable fastening means.

The connection between connecting means 18 and the object 12 carried by apparatus 10 may be influenced by the nature of the object as well as the desires or needs of the end user. In any case, whether permanent or releasable, the particular manner by which an object 12 is attached to connecting means 18 does not constitute a central part of the present invention. Accordingly, it will be appreciated that appropriate connectors for particular purposes, whether presently available or hereinafter developed, will manifest themselves to those of ordinary skill in the subject art.

Reference numeral 30 identifies a pressure gauge in communication with tank 28 and reference numeral 32 identifies a barrel from which fishing bait and/or lure(s) may be discharged in the manner described in U.S. patent application Ser. No. 11/229,993.

Connecting means 18 includes means for adjusting the attitude, particularly the pitch, of object 12 (as indicated by double-headed arrow 34 located adjacent the mouth of barrel in FIG. 1). According to the invention, the attitude adjustment means comprise cooperating means carried by the first and second bracket members 20 and 22 for disposing the second bracket member in selected arcuate positions with respect to said first bracket member. Pursuant to presently preferred embodiments, the cooperating means may comprise a pin member carried by one of the first and second bracket members and arcuately arranged means for receiving the pin member carried by the other of the first and second bracket members. In the example depicted in FIGS. 1 and 2 the pin member is identified by reference numeral 36 and the arcuately arranged means for receiving the pin member is an arcuate slot provided in second bracket member 22 and identified by reference numeral 38. Referring to FIG. 2, although not shown, the pin member is provided at a first end of a handle 40, which handle may include a knob 42 for ease of handle manipulation and user comfort. Preferably, pin member 36 is a threaded portion of handle 40 or a screw or bolt integral with the handle. The threaded pin member is either threaded into a corresponding threaded bore provided in the first bracket member 20 or an unillustrated nut located on the face of the first bracket opposite the second bracket member. So constructed, the second bracket member 22 and object 12 supported thereby may be pitched forwardly or rearwardly about pivot 24 to a desired position within the range of motion permitted by slot 38. Once the desired position is selected, the handle is then turned to thread pin member 36 either into the first bracket member or a corresponding nut to clamp the position of the second bracket member with respect to the first bracket member. To change the pitch of the object, the threaded pin member is loosened, the object is readjusted and the threaded pin member is retightened.

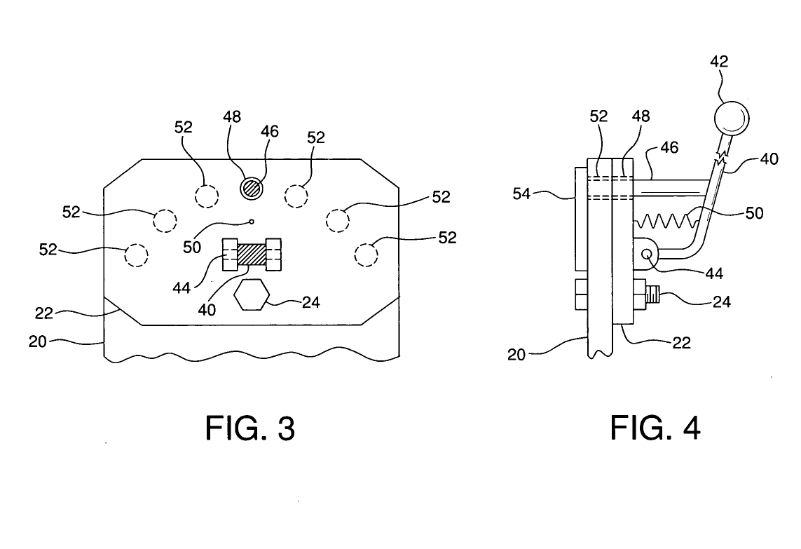

Alternative attitude adjustment means are illustrated in FIGS. 3 and 4. As shown in those figures, handle 40 is pivotally connected as indicated by reference numeral 44. Handle 40 carries an integral pin member 46 that passes through an aperture 48 provided in second bracket member 22. FIG. 4 reveals that a spring 50 biases handle 40 and pin member 46 toward the first and second bracket members 20 and 22. In the embodiment shown in FIGS. 3 and 4 the arcuately arranged means for receiving pin member 46 is a plurality of apertures 52 provided in first bracket member 20 arranged in and arced array. FIG. 4 shows that first bracket member 20 includes a plate 54 on its rear surface to prevent over-insertion of pin member 46 into apertures 52 under the influence of spring 50 on handle 40. Using the attitude adjustment assembly shown in FIGS. 3 and 4, a user pulls handle 40 outwardly against the force of spring 50 thereby withdrawing pin member 44 from an aperture 52. While holding the handle outwardly, the user pitches the object carried by the apparatus a desired degree until aperture 48 in second bracket member 22 comes into alignment with another aperture 52 in first bracket member 20. The handle is then released and the pin member is drawn into the newly selected aperture 52 under the force of spring 50.

Still other attitude adjustment means may include cooperating arcuately arranged corrugations, teeth or other similar mating means provided on the abutting faces of the first and second bracket members 20 and 22.

FIGS. 5 and 6 depict the structure and operation of anchor means 16. The anchor means preferably comprise a first upper hollow anchor member 56 and a second lower hollow anchor member 58. The first and second hollow anchor members have opposed cooperating sloped surfaces 56a and 58a, respectively. A rod 60, preferably a threaded rod for ease of construction, is situated in anchor members 56 and 58. As illustrated, rod 60 has a first end fixedly connected to anchor member 58 via a nut 62 that abuts a plate 64 affixed to the interior of anchor member 58. Preferably, although not necessarily, anchor member 58 includes a second plate 66 and second nut 68 for relieving stress on nut 62 and plate 64.

The second end of rod 60 is connected to anchor member 56 by a spring assembly 70 including a spring 72. A handle 74 is pivotally connected at 76 to tabs 78 affixed to anchor member 56. The handle passes through an opening 80 in anchor member 56 and handle 74 may include a knob 82 for ease of use and user comfort. Handle 74 is provided with an opening 84 through which rod 60 passes. The range of motion of motion of handle 74 along rod 60 is limited by upper and lower nuts 86 and 88 which are larger in size than handle opening 84 in order to prohibit their entry into opening 84. Optionally, either or both of anchor members 56 and 58 may be provided with protective outer sleeves 90 to minimize wear and tear on the anchor means 16.

As seen in FIG. 5, when a user desires to insert or withdraw anchor means 16 into or from tubular member 14, or to simply adjust the position of the anchor means in the tubular member, the user moves handle 74 downwardly. In the process, the handle comes into contact with nut 88. Thereafter, continued downward movement of the handle exerts force against spring 72 of spring assembly 70 whereby the anchor members 56 and 58 are moved along the cooperating sloped surfaces 56a and 58a into a contracted inoperative position.

Conversely, as seen in FIG. 6, once the anchor means 16 is placed at a desired position within tubular member 14, the user releases handle 74. Upon release of the handle anchor members 56 and 58 move in the opposite direction along sloped surfaces 56a and 58a under the influence of spring 72 into an expanded operative position whereby the anchor members frictionally engage the inner wall of tubular member 14 and secure apparatus 10, and thus any object supported thereby, to the tubular member.

It will be understood that the construction of anchor means 16 shown in FIGS. 5 and 6 is merely illustrative of one type of anchor means that could be used in apparatus 10 in order to secure the apparatus to a tubular member. By way of example, the entire assembly shown in FIGS. 5 and 6 may be inverted and similar results will be achieved. Moreover, any anchor means that can releasably secure apparatus 10 to a tubular member may function as a suitable anchor means for the purposes of the present invention.

Apparatus 10 as described herein provides advantages in object attitude adjustability heretofore unattainable by object-supporting, tubular member-engaging devices known in the art. The present apparatus provides a device that not only can be disposed in any rotational position in the tubular member within which it is received but also allows the pitch of an object supported by the apparatus to be easily adjusted to accommodate the peculiarities of the object and/or a user's wants or needs.

Although the invention has been described in detail for the purpose of illustration, it is to be understood that such detail is solely for that purpose and that variations can be made therein by those skilled in the art without departing from the spirit and scope of the invention as claimed herein.

What is claimed is:

1. Apparatus for securing an object to a tubular member, the apparatus comprising:
anchor means for releasably engaging a tubular member; and
means for connecting an object to said anchor means, said connecting means including means for adjusting the pitch of an object carried by the apparatus.

2. The apparatus of claim 1 wherein said connecting means comprise a first bracket member connected to said anchor means and a second bracket member adapted for connection to an object.

3. The apparatus of claim 2 wherein said attitude adjustment means comprise means for pivotally connecting said first and second bracket members.

4. The apparatus of claim 3 wherein said attitude adjustment means comprise means for pivotally connecting said first and second bracket members.

5. The apparatus of claim 4 wherein said attitude adjustment means further comprise cooperating means carried by said first and second bracket members for disposing said second bracket member in selected arcuate positions with respect to said first bracket member.

6. The apparatus of claim 5 wherein said cooperating means comprise a pin member carried by one of said first and second bracket members and arcuately arranged means for receiving said pin member carried by the other of said first and second bracket members.

7. The apparatus of claim 6 wherein said arcuately arranged means is an arcuate slot.

8. The apparatus of claim 6 wherein said arcuately arranged means is a plurality of spaced apart apertures arranged in an arcuate pattern.

9. The apparatus of claim 6 wherein said attitude adjustment means further comprise a handle carried by one of said first and second bracket members and wherein said pin member is connected to said handle.

10. The apparatus of claim 8 wherein said attitude adjustment means further comprise a handle carried by one of said first and second bracket members and wherein said pin member is connected to said handle.

11. The apparatus of claim 10 wherein said handle pivotally connected to one of said first and second bracket members.

12. The apparatus of claim 11 further comprising means for biasing said handle such that said pin member is biased toward said apertures.

13. The apparatus of claim 1 wherein said anchor means comprise:
first and second hollow anchor members having opposed cooperating sloped surfaces;
a rod situated in said anchor members, said rod having a first end fixedly connected to one of said anchor members and second end connected by a spring to the other of said anchor members, said spring being operable to urge said first and second members into an expanded operative position whereby the anchor members frictionally engage an inner wall of a tubular member to secure an object to a tubular member; and
a handle pivotally connected to one of said anchor members and operatively connected to said rod to axially move said rod within said anchor members in opposition to said spring whereby said first and second anchor members are moved into a contracted inoperative position to permit insertion of the apparatus into and withdrawal of the apparatus from a tubular member or adjustment of the position of the apparatus with respect to a tubular member.

14. A fishing bait casting apparatus adapted for securement to a tubular member, the apparatus comprising:
a fishing bait casting device;
anchor means for releasably engaging a tubular member; and
means for connecting said fishing bait casting device to said anchor means, said connecting means including means for adjusting the pitch of said fishing bait casting device.
